(19) United States
(12) Patent Application Publication
(10) Pub. No.: US 2002/0025046 A1
(43) Pub. Date: Feb. 28, 2002

(54) Controlled proxy secure end to end communication

(76) Inventor: Hung-Yu Lin, San Diego, CA (US)

Correspondence Address: DANIEL ROBBINS, 3346A INDUSTRIAL COURT, SAN DIEGO, CA, 92121, US

(21) Appl. No.: 09/854,101

(22) Filed: May 11, 2001

Related U.S. Application Data
(60) Provisional application No. 60/203,767, filed on May 12, 2000.

(51) Int. Cl. H04L 9/32; H04L 12/22

(52) U.S. Cl. 380/282; 713/171; 380/30; 713/201

(57) ABSTRACT

A session key is developed for communication between two end to end users where one or both of the end users do not have the computation capability of carry out all the steps required to generate a secure session key. End user limitations may include lack of computer storage, bandwidth or power supply capability to support the programs necessary for the computation and authentication of the protocol steps. The invention teaches the use of at least one intermediary proxy, which may be network servers or a telephone service providers, and who hold securitiy certificates supporting the use of public and private keys in the transmission of encrypted information. The end users channel their requests through the proxies, who perform the protocol computations and act as trusted intermediaries in transferring the computation results between the end users in establishing a secure session key.

### BACKGROUND OF THE INVENTION

1. Field of the Invention

This invention relates to digital communication, and in particular to secure communication using cryptographic techniques.

2. Description Relative to the Prior Art

Communication security continues to be one of the major concerns in network applications. Many mechanisms have been developed to improve the security of communication over the Internet. For example, IP Security (IPSec) implements security mechanisms in the Internet Protocol (IP) to provide a general purpose transparent solution to upper layer applications. Secure Socket Layer (SSL) or Transport Layer Security (TLS) implements security mechanisms on top of TCP for HTTP, SMTP and FTP. Other application specific protocols like PGP, PEM and S/MINE for secure emails, Kerberos for authentication service and Secure Electronic Transaction (SET), are also available to provide application specific services. These security services mainly are designed for TCP/IP networks and client/server computation paradigms. They assume that users have adequate computation resources, including hardware, software and communication bandwidth to carry out the required operations. Wireless network users who communicate with simple handheld devices or end user users who travel away from their computer/network base, may not have adequate computation resources, and therefore temporarily lose the support of home based security services.

Secure end-to-end communication requires that the communicating parties verify each other's claimed identity, and to establish a session key for message encryption and decryption after a successful mutual authentication. This session key can be derived from a shared secret through challenge-response interactions. The shared secret can be a short password as used in the Encrypted Key Exchange (EKE) protocols, but usually it is a long random bit sequence, ranging from 64 to 256 bits, which is hard to remember. Since one may want to have secure communications with many others, it is almost impossible for one to share a different secret with all potential communicating partners.

A more suitable approach is to derive the session key through the use of key agreement protocols based on private key/public key and digital signature techniques known in the art. However, such private key/public key techniques entail expensive encryption/decryption operations, and require additional software support for verification of certificates and digital signatures. This is feasible for computer users having sufficient computation power and bandwidth, but for mobile stations, this approach becomes impractical. Computation of the session key and verification of signatures and certificates require significant memory space, hardware and power capabilities. A end user device, such as a PCS phone is limited in these essentials, and more importantly, with limited bandwidth the delay in execution of the required programs would be intolerable.

The present invention is directed towards solving the above problems by providing apparatus and a method for overcoming the obstacles to providing secure session keys for transmissions between end users having various levels of computing power.

The public key/private key, digital signature protocols referenced above are described in the Background of the Disclosure of U.S. Pat. No. 4,405,829 issued in the names of Rivest et al, and is hereby incorporated by reference.

### SUMMARY OF THE INVENTION

The present invention discloses apparatus and a method for end-users requiring secure communication but not having adequate computation power, bandwidth or power supply capacity to implement the necessary security protocols. Two end-users, employing communication devices subject to such constraints, may engage in secure communication by delegating the execution of the required complex computation, certification and authorization protocols to proxies not subject to these limitations. In the preferred embodiment, two certified proxies have the computation power to perform real time calculations necessary to generate a session key for valid communication between the end users over a standard communication channel. Each end user will then communicate by encrypting and decrypting their messages by means of the generated session key. The resultant session key is a binary string of 1's and 0's, and is symmetrically used by each of the end users. The device at the sending end has sufficient computation ability to implement the Data Encryption Standard (DES) by applying the generated session key to the outgoing message for encryption, and the receiving end device is capable of applying the session key to the data stream in conjunction with DES decryption to recover the message. It will be appreciated that the proxies carry the burden of authenticating the mutual transmissions to insure the end users, and each other, that the transfers of information in the process of generating the session key, are secure. Digital signatures, encrypted sensitive data, and challenges and responses further insure that the parties are the valid participants. This procedure for generating the session key by utilizing the power of proxies provides end users with an effective security environment. In a second embodiment, where one of the end stations has adequate capability for computation and authentication, a single proxy is employed to interface with the end user not having the necessary capability.

### BRIEF DESCRIPTION OF THE DRAWINGS

The invention will be described with respect to the figures of which:

FIG. 1 is a block diagram of the apparatus of the invention,

FIG. 2 is a flow diagram of information generated by end user station-1 for transfer to proxy 1,

FIG. 3 is a flow diagram of information generated by proxy-1 for transfer to proxy-2,

FIG. 4 is a flow diagram of information generated by proxy-2 for transfer to end user station-2,

FIG. 5 is a flow diagram of information returned from end user station-2 to proxy 2,

FIG. 6 is a flow diagram of information returned from proxy-2 to proxy-1,

FIG. 7 is a flow diagram of information returned from proxy-1 to end user station 1,

FIG. 8 is a flow diagram of processing information by end user station-1 to generate the session key,

FIG. 9 is a block diagram of a second embodiment of the invention, and

FIGS. 10-18 are flow diagrams for the second embodiment of the invention wherein one end station is capable of session key computation and authentication, and the second end station is limited in such capability, precluding its ability to fully effect the required computations necessitated by the invention. Note that a user can instruct an end user station to change its behavior. For example, a desk top computer capable of performing signature and identity verification may be instructed to act like a handheld device that needs the help of a proxy to establish a secure end-to-end communication with another end user station. Therefore, a proxy does not exactly know the machine that it is serving is a desktop computer or a handheld device.

### DESCRIPTION OF THE PREFERRED EMBODIMENTS

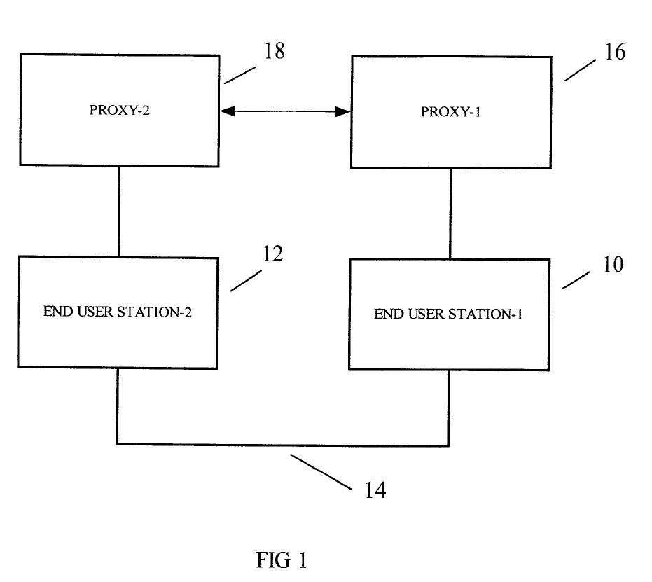

Referring to FIG. 1, an originating end user station, 10, initiates action to establish secure communication over network, 14, with a terminating end user station 12. Secure communication requires the derivation of a common session key between end user station 10 and end user station 12 which will be used to encrypt and decrypt the messages between end user stations 10, 12, and mutual authentication that the communicators are who they say they are. However, the computing power, memory capacity and supply power of the end user stations 10, 12, (which may be portable devices), may not be sufficient to carry out the computer operations necessary to generate the required session key and the authentication. End user stations 10, 12, therefore, can establish, respectively, their servers as proxies 16, 18. Servers 16, 18, may be telephone service providers or Internet service providers, and they have the necessary hardware and software capability to assume the burdens of computing the required session key, and more importantly, to act as intermediaries in determining the authenticity of the end user stations, 10, 12, and proxies 16, 18. This relationship requires the establishment of trust between the end user station 10 and its proxy 16, and between end user station, 12, and its proxy 18. Each proxy 16, 18 is entrusted to authenticate of its respective client 10, 12, and this requires that the certificate, obtained from a recognized Certificate Authority be in the proxy's possession. Additionally, in communications between the proxies 16, 18, the end user stations 10, 12, rely on the proxies 16, 18 to use public and private security keys, in accordance with procedures known in the art, to provide secure transmissions, including valid digital signatures, in the inter-proxy communications required to compute and validate the messages for their clients, end user stations 10, 12. End user stations 10, 12 use confidentially maintained passwords in their respective interactions with their proxies 16, 18.

The derivation of the session key requires extensive computations in a Galois field G(P), where P is a large prime such that P−1 does not consist entirely of small factors. For example, P may be a prime wherein 2⁵¹¹<P<2⁵¹², and P is generated by g, a primitive root of P. A primitive root of P is one whose powers generate all the integers from 1 to P−1; that is, g mod P, g² mod P, . . . g^{P-1} mod P are all distinct, and consist of the integers from 1 to P−1. The value of g and P may be known in advance to the four parties involved in the derivation and use of a session key. All computations are performed mod P.

An essential feature of the present invention is that after each interchange of information, confirmation of the origin of the information by means of challenges and responses, as well as valid identity authentications takes place, as will be explained in detail below.

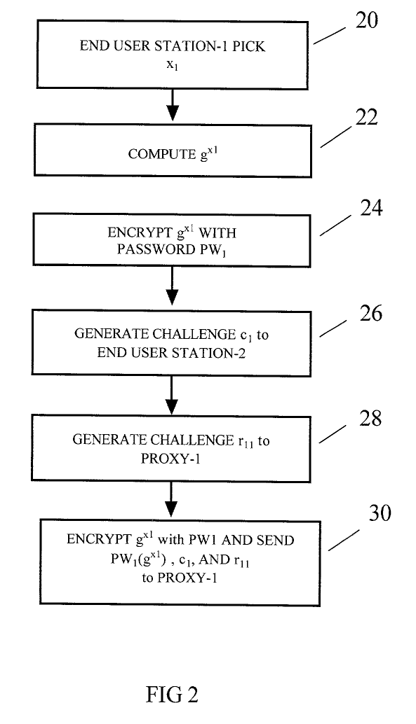

Referring to FIG. 2, the generation of the session key formation is initiated by end user station-1, 10, by selection, 20, of a secret number x₁, and computing, 22, an ephemeral key g^{x1}.

It then encrypts, 24, using its password shared with proxy-1, 16. It also generates, 26, an end to end challenge, c₁, to end user station-2, 12, and generates, 28, a challenge, r₁₁, to proxy-1, 28. End user station-1, 10, transfers, 30, to proxy-1, 16, g^{x1} encrypted with end user station-1's password, and challenge r₁₁ to proxy-1, 16 and challenge c₁ to end user station-2, 12, in the clear.

Proxy-1, 16, and proxy-2, 18, each have their own public key which has been certified by an independent Certification Authority. Therefore the proxies, 16, 18 have the authority to compute digital signatures for their messages. This capability is utilized in the next step of forming the session key to be used by the end user stations 10, 12.

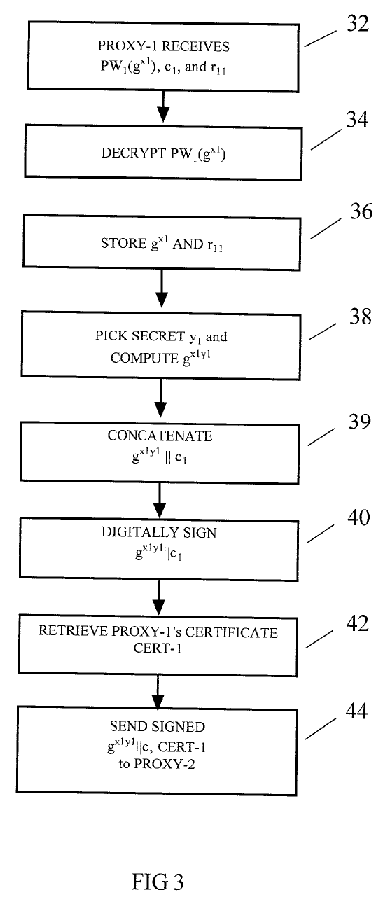

Referring to FIG. 3, proxy-1, 16, receives, 32, from end user station-1, 10, g^{x1} encrypted with password-1 (PW₁), end to end challenge c₁, and end user station-1, 10, challenge to proxy-1, 16, r₁₁. Proxy-1, 16, decrypts, 34, the password-1 (PW₁) encrypted ephemeral key g^{x1}, storing, 36, it and the challenge r₁₁ Proxy-1 then picks its secret number y₁ and computes, 38, g^{x1y1}. Proxy-1, 16, concatenates c₁, 39, with g^{x1y1} resulting in (g^{x1y1}∥c₁), then digitally signs, 40, with its own private key the partially calculated session key g^{x1y1} concatenated with c₁. (Concatenation of a with b is displayed as a∥b.) It finally retrieves, 42, its certificate from storage, and transmits, 44, signed (g^{x1y1}∥c₁), and its certificate to proxy-2, 18.

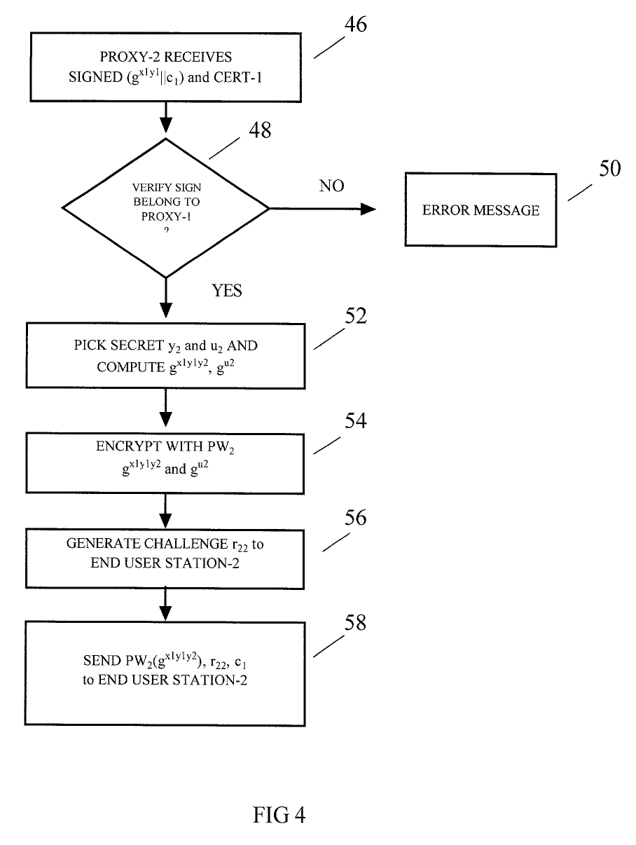

Referring to FIG. 4, proxy-2, 18 receives, 46, the signed g^{x1y1}, end-to-end challenge c₁, and proxy-1's, 16, certificate. Proxy-2, 18, checks, 48, the received digital signature and certificate, and verifies that it, in fact, is from proxy-1, 16. If the verification fails, an error message is returned 50 to proxy-1 and the protocol is stopped. If the verification succeeds, proxy-2, 18, picks its secret numbers y₂ and u₂, and computes g^{x1y1y2} and g^{u2}. The computed g^{u2} is a interim key for later use with end user station-2, 12. Proxy-2, 18, encrypts, 54, g^{x1y1y2} and g^{u2} with end user station-2's, 12, password, PW2 and selects a challenge r₂₂ to end user station-2. Proxy-2, 18, then sends 58 the encrypted information PW₂(g^{x1y1y2}∥g^{u2}), r₂₂, c₁ to end user station-2, 12.

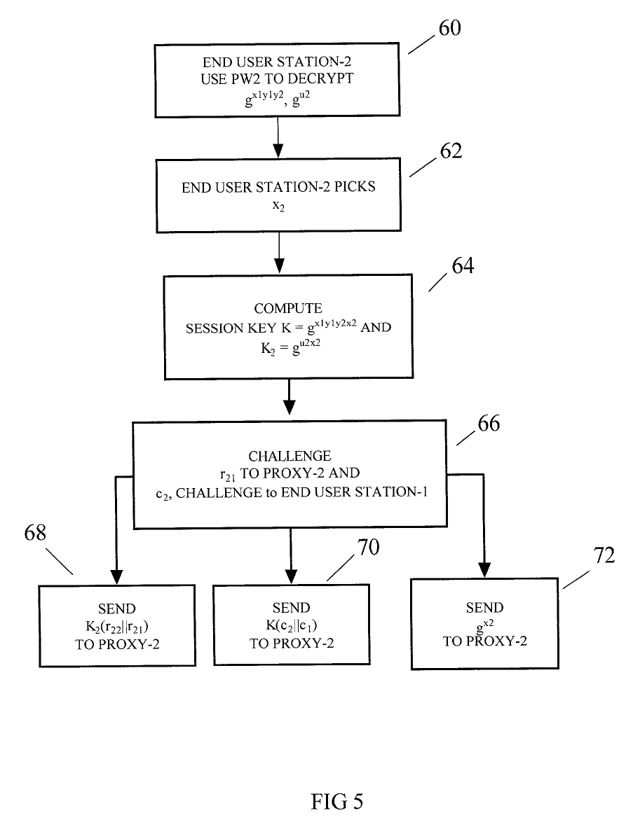

Referring to FIG. 5, end user station-2, 12, uses, 60, its password PW2 to decrypt proxy-2's, 18, message, recovering g^{x1y1y} and proxy-2's interim key g^{u2}. End user station-2 picks, 62, its secret number x₂, and computes, 64, K=g^{x1y1y2x2}, which is the end-to-end session key, and also computes, 64, K₂=g^{u2x2}, a local session key for communications with its proxy-2, 18. It selects, 66, a challenge to proxy-2, 18, r₂₁, and a challenge to end user station-1, 10, c₂. It then responds to proxy-2, 18, by sending, 68, to proxy-2, 18, using the interim key, K₂, the encryptd message K₂(r₂₂∥r₂₁), and sending, 70, the message K(c₂∥C₁). It also forwards, 72, g^{x2} to proxy-2.

At this point it will be appreciated that the session key K has been sequentially computed by contributions of secret numbers from each of the participants, but the end-to-end session key K is only in the possession of end user station-2, 12. Starting with g^{x2} being transferred back to proxy-2, 18, the end-to-end session key, K, will be recalculated using the same contributions in reverse from each party until the end-to-end session key K is re-generated by end user station-1, 10. These reverse direction calculations will also be accompanied by authentication and confirmation of the identities of the parties involved.

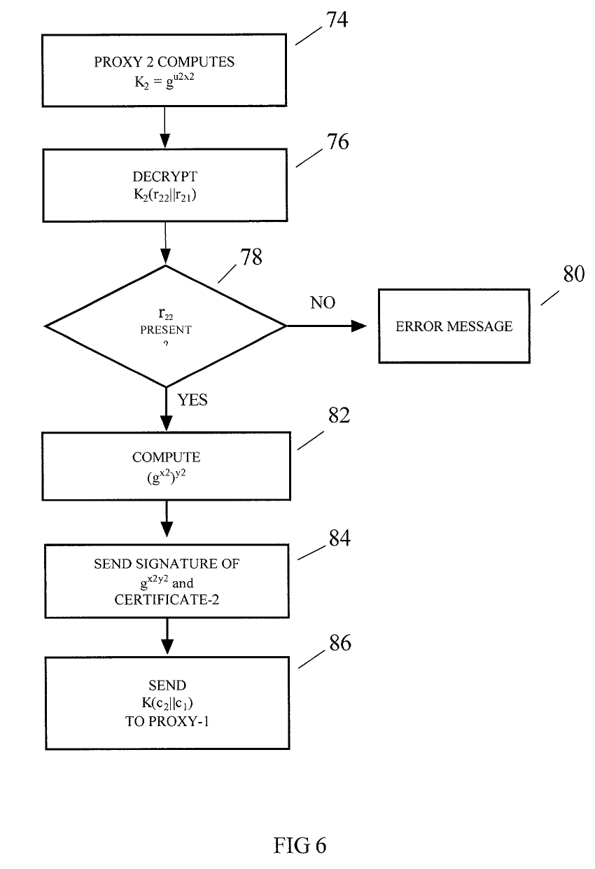

Referring to FIG. 6, proxy-2, 18, computes, 74, the local session key K₂=g^{u2x2} which allows proxy-2, 18 to decrypt, 76, end user station-2's, 12, encrypted K₂(r₂₂∥r₂₁). The next step is deciding,72, whether its challenge r₂₂ is present. If r₂₂ is not returned by end user station-2, 12, proxy-2, 18, stops the protocol and sends 80 error messages to the other parties so advising them. If r₂₂ is present, the protocol is continued and proxy-2, 18, computes (g^{x2})^{y2}, where y2 is in storage from previous steps in the protocol. Proxy-2, 18, then digitally signs, 84, g^{x2y2}, and sends 86, the digital signature of g^{x2y2} and its certificate to proxy-1, 16, along with end user station-2's end-to-end challenge and response pair K(c₂∥c₁).

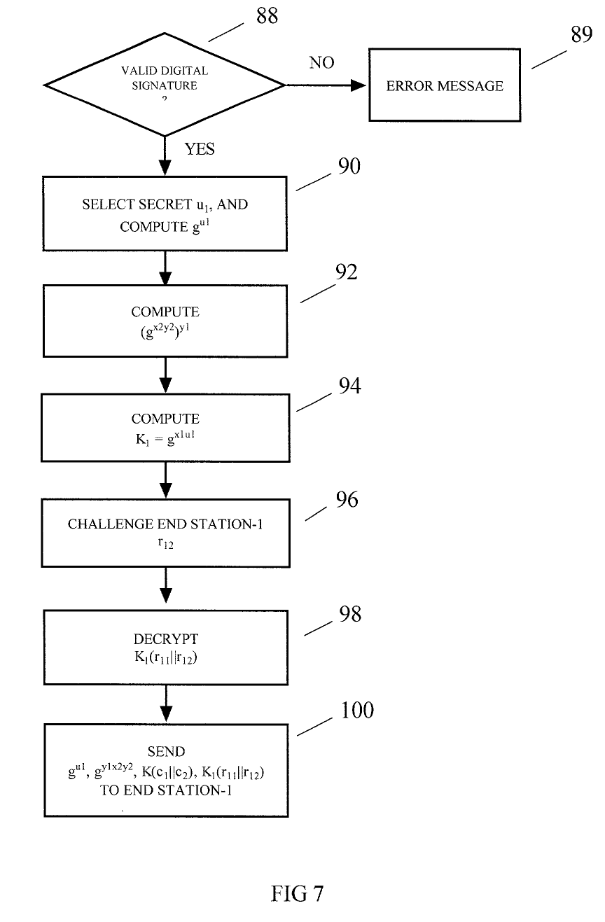

Referring to FIG. 7, proxy-1, 16, receives digital signature of g^{x2y2} from proxy-2, 18, and verifies, 88, whether the signature is legitimate. If not, it stops, 89, the protocol and advises the parties of the failure of the protocol. If the digital signature is legitimate, it chooses a secret number u₁ and computes, 90, g^{u1}. It also computes, 92, (g^{x2y2})^{y1} from its own secret y₁ and the received g^{x2y2} and also computes, 94, K₁=g^{x1u1}, which is a local session key for communication with end user station-1, 10. A challenge is generated, 96, r₁₂, for challenging end user station-1, 10, and using K₁ it forms K₁(r₁₁∥r₁₂). Proxy-1, 16, then sends, 100, gu^{u1}, g^{y1x2y2}, K₁(r₁₁∥r₁₂), and the received K(c₂∥c₁) to end user station-1, 10.

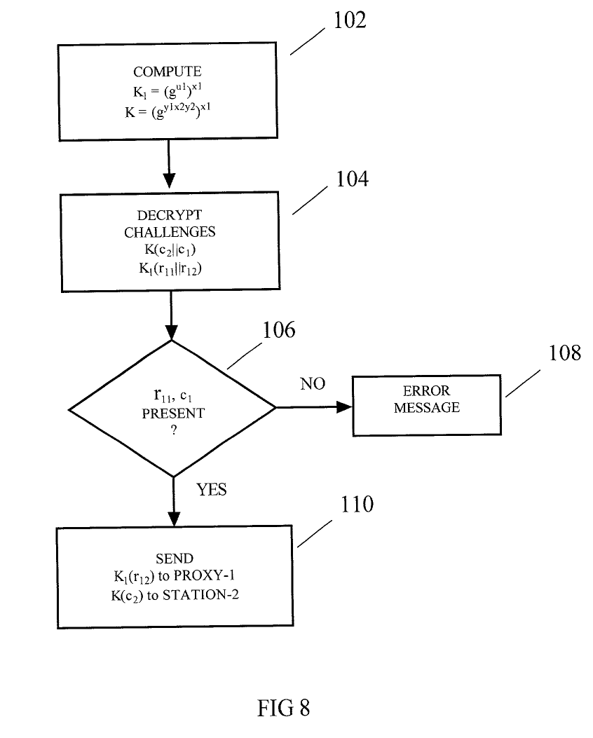

Referring to FIG. 8, end user station-1, 10, computes, 102, K₁=(g^{u1})^{x1} and the session key K=(g^{y1x2y2})^{x1} from the values just received from proxy-1, 16. Note that both end user station-1, 10 and end user station-2 now have the completely computed end-to-end session key, K. The rest of the protocol consists in confirming, if desired, that the participants are all legitimate parties to the formation of the session key. End user station-1, 10, may now verify 106 that its challenge r₁₁ to proxy-1, and c₁ its end-to-end challenge to end user station-2, 12, are confirmed by having received back the challenge words that it originally sent out. If the correct responses are not present, the protocol is cancelled 108 with error messages sent to the participants. If the challenge responses are correct, end user station-1 uses local session key K₁, to send, 110, r₁₂ to proxy-1 confirming to proxy-1, 16 that it is in fact end user station-1, 10, and sending, 110, K(c₁∥c₂) to proxy-1, 10 for forwarding on to end user station-2, 12, via proxy-2, 18.

It will be noted that the proxies never have the complete end-to-end session key in their possession; they only have the intermediate computations that are passed on to the end user stations of the session key. However, while the chance is small, a proxy may carry out a man-in the middle attack by impersonating a legitimate user station and establishing two “bogus” secure connections to each of participating end user stations. To prevent this attack, an end user station, can request the other end user station to sign the response of the end-to-end challenge K(c₂∥c₁) and/or K(c₂). If the proxy launched the man in the middle attack, the resultant session key K used for communication will be different from the one used to compute the response, and such an attack will be detected. Because the proxy has no idea whether an end user's station has the power to do signature verification, the proxy will be forced to faithfully provide its service.

In the embodiment described above, it has been assumed that either of the end user stations 10, 12 may lack the facilities for computing and authenticating the secure session key, K, and had to rely on their proxies 16, 18. However, the teachings of the invention are not limited to this particular configuration of end user stations. In a second embodiment, one of the end stations may have adequate capability to both perform the necessary computations and to perform the authentication process. For convenience, but not as a limitation, this end station is represented as a “desk computer”, and the end user station incapable of performing all the necessary steps is represented as a “hand held” device.

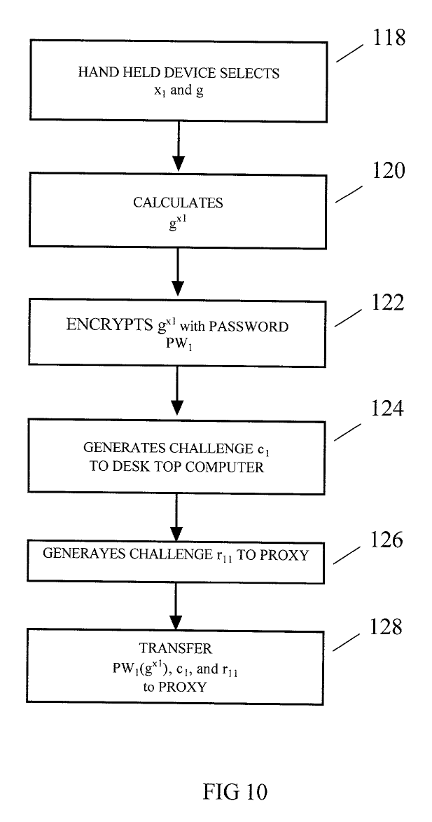

It will be understood that the basic protocol followed in this second embodiment follows the same steps as described in the first embodiment, but because of the capability of the end user labeled “desk computer”, certain steps are compressed as this end user can provide some of the functions previously specified as a proxy function. The sequence of steps in implementing the protocol depends upon whether the request for communication is initiated by the “desk top computer” or the “hand held device”. The flow charts of FIGS. 10-14 and 15-18 illustrate these two configurations for performing end-to-end communication. While the overall protocol is basically the same whichever end station initiates the communication, the individual steps depend upon the originating station, and both routines will be described below.

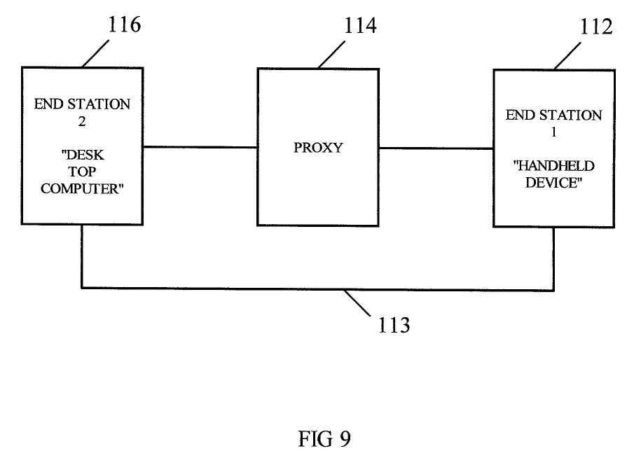

Referring to FIG. 9, a hand held communication device, 112, of limited computation power communicates, 113, with a desk top station 116 that does have adequate communication power to support generating a session key. This embodiment discloses an auxiliary proxy, 114, which interfaces with the hand held device 112 and the desk top computer 116, and which provides the computation power lacking in the hand held device 112.

Referring to FIG. 10, the hand held device, 112, selects secret number x₁ and the primitive root g. It computes, 120, g^{x1} and encrypts g^{x1} with password PW₁, 122. It also generates, 124, a challenge c₁ for desk top computer 116, and generates 126 a challenge r₁₁ to the proxy 114. It then transfers, 128, PW₁(g^{x1}), c₁, and r₁₁ to proxy, 114.

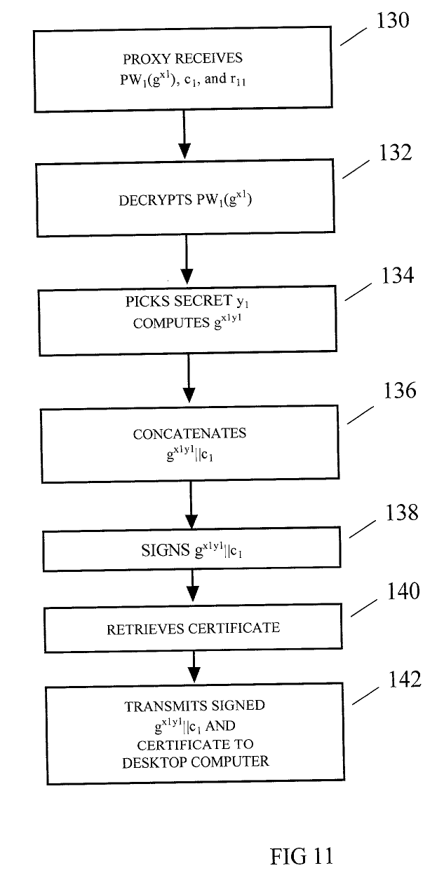

Referring to FIG. 11, proxy, 114, receives, 130, PW₁(g^{x1}), c₁, and r₁₁ and, 132, decrypts g^{x1} under PW₁. Proxy, 114, picks secret number y₁ and computes, 134, g^{x1y1}. It concatenates c₁ and g^{x1y1}, c₁∥g^{x1y1} and digitally signs, 138, the combination. It retrieves 140 its certificate and transmits 142 the digitally signed data, and the certificate to the desk top computer, 116.

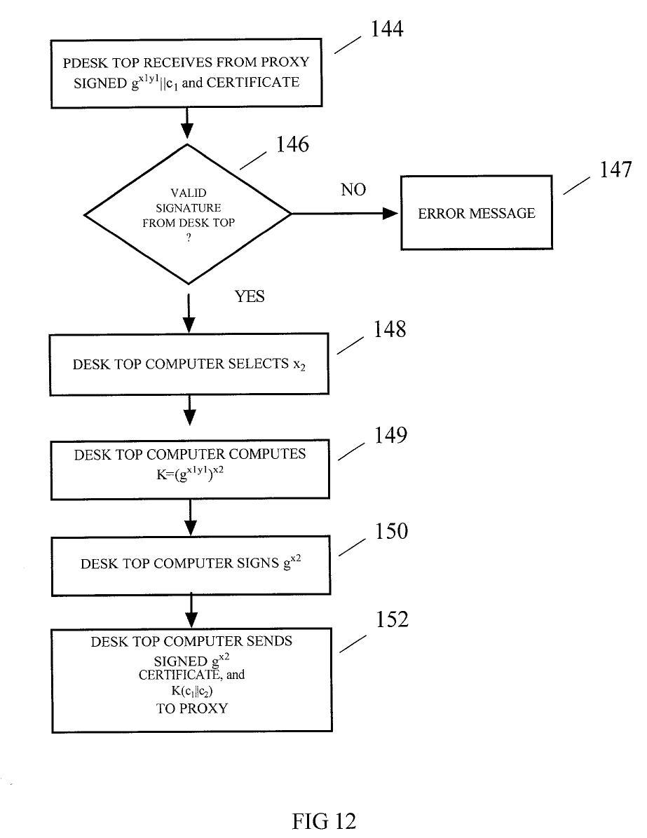

Referring to FIG. 12, the desk top computer, 116, receives signed c₁g^{x1y1} and certificate from the proxy, 144, and verifies, 116, that the digital signature is valid. If validation, 146, fails, and error message, 147, is sent to the other parties of the system, and the protocol is aborted. If validation is approved, the desk top computer, 116, selects, 148, its secret number x₂, and computes 149, the session key K=(g^{x1y1})^{x2}. It then picks its end-to-end challenge c₂, digitally signs g^{x2} and sends, 152, the signed message, its certificate and K(c₁∥c₂) to proxy 114.

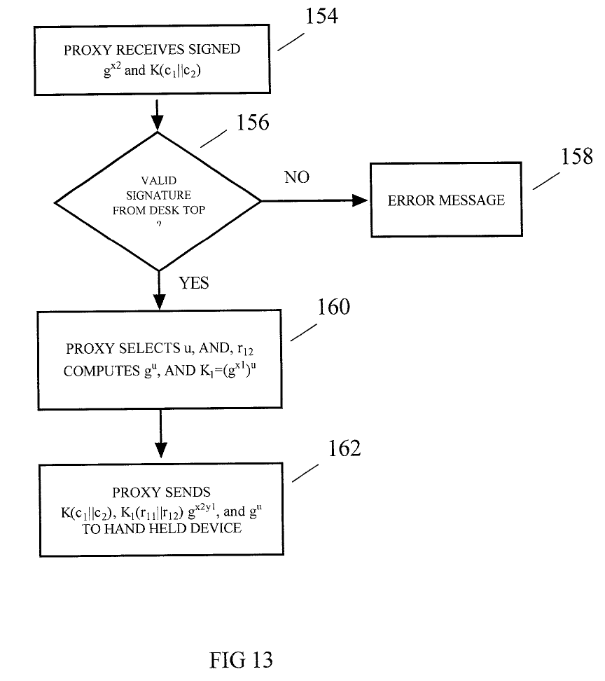

Referring to FIG. 13, the proxy, 114, receives the signed message, g^{x2}. It, 156, checks the validity of the signed message, and if it is not valid, error messages are sent, 158, to the end users, and the protocol stops. If the signature is valid, the proxy 114 selects another key u, and r₁₂ and computes 160, interim key g^{u} and local session key K₁=(g^{x1})^{u}. The proxy, 114, sends, 162, K(c₁∥c₂), K₁(r₁₁∥r₁₂), (g^{x2})^{y1}, and g^{u} to the hand held device 112.

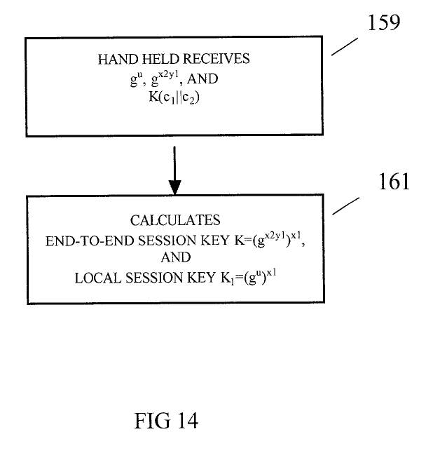

FIG. 14 shows the hand held device 112 receives 159, g^{u}, g^{x2y1}, and K(c₁∥c₂). The hand held device, now can compute the end-to-end session key K=(g^{x2y1})^{x1}, local session key K₁=(g^{u})^{x1}, and can securely communicate with the desk top computer, 116, on communication channel 113.

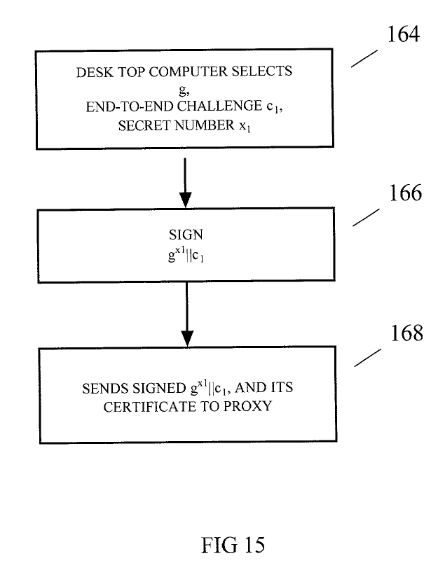

In the other scenario, where the desk top computer 116 initiates the request for communication, FIG. 15 illustrates the desk top computer, 116, selects, 164, g, challenge c₁, and secret number x₁. It signs (g^{x1}∥c₁), and transmits, 168, it to proxy, 114, along with its certificate.

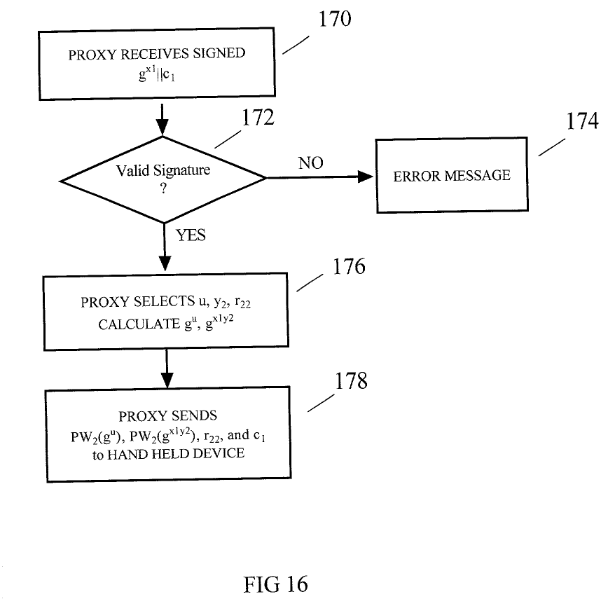

Referring to FIG. 16, proxy, 114, receives, 170, signed (g^{x1}∥C₁). Checking, 172, the validity of the signed message; if it is not valid, an error message is generated, 174, and sent to all parties. If it is valid, proxy, 114, the proxy selects secret number u and secret number y₂. It also selects challenge r₂₂, and 176 calculates g^{u} and g^{x1y2}. Proxy 114 sends,178, PW₂(g^{u}) and PW₂(g^{x1y2}), challenge r₂₂ and c₁ to the hand held device, 112.

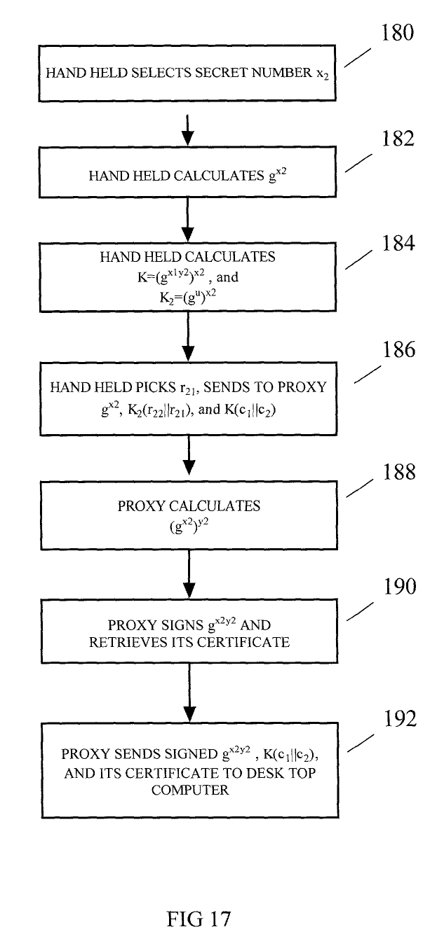

In FIG. 17, the hand held device, 112, selects, 180, a secret number x₂, and calculates g^{x2}, 182. It also calculates, 184, K=(g^{x1y2})^{x2} and K₂=(g^{u})^{x2}. It picks challenge r₂₁, sends, 186, to proxy, g^{x2}, K₂(r₂₂∥r₂₁), and K(c₁∥c₂). Proxy calculates (g^{x2})^{y2} and digitally signs g^{x2y2} and retrieves its certificate, 190. It then sends the signature, its certificate, and K(c∥c₂) 192 to the desk top computer, 116.

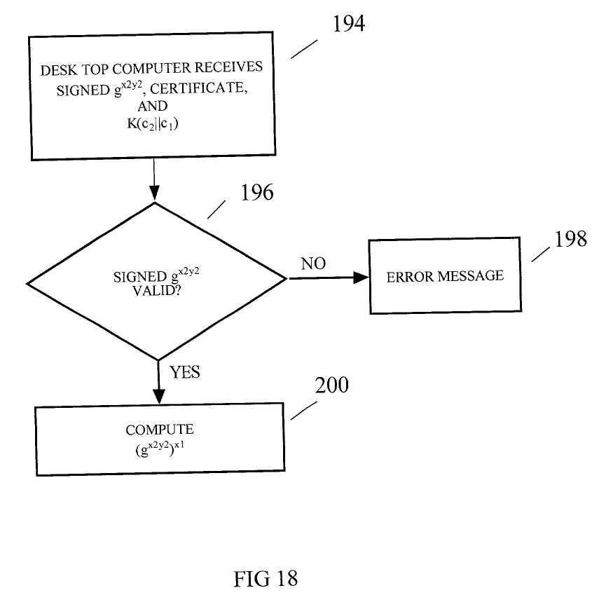

In FIG. 18, the desk top computer, 116, receives digitally signed g^{x2y2}, the certificate, and K(c₁∥c₂). It validates, 196, the received information, and if validation fails, sends error messages to the parties, 198. If validation is approved, the desk top computer can now compute 200 the session key, K=(g^{x2y2})^{x1}.

The invention has been disclosed in terms of preferred embodiments, but it will be understood that variations and modifications can be effected within the scope and spirit of the invention.

What is claimed is:

1. A method of providing a secure session key for message transmissions between first and second communication locations, said method comprising the steps of:
a) selecting a first secret number by said first communication location,
b) generating a first ephemeral number from said first secret number by said first communication location,
c) sending said first ephemeral number from said first communication location to a first proxy station,
d) selecting a second secret number by said first proxy station, and computing a first composite number from said first ephemeral number and said second secret number,
e) sending said first composite number to a second proxy station,
f) selecting a third secret number by said second proxy station, and computing a second composite secret number from said first composite number and said third secret number,
g) sending said second composite number to said second communication location,
h) selecting a fourth secret number by said second communication location, computing a second ephemeral number from said fourth secret number, and computing a third composite number from said second composite number and said fourth secret number, whereby said session key equal to said third composite number is generated at said second communication location,
i) sending said second ephemeral number by said second communication location to said second proxy station,
j) retrieving said third secret number by said second proxy station, and computing a fourth composite number from said fourth secret number and said third secret number,
k) sending said fourth composite number from said second proxy station to said first proxy station,
l) retrieving said second secret number by said first proxy station, and computing a fifth composite number from said fourth composite number and said second secret number,
m) sending said fifth composite number from said first proxy station to said first communication location,
n) retrieving said first secret number by said first communication location and recovering said session key from said fifth composite number and said first secret number at said first communication location.

2. The method of claim 1 wherein said computing is computing modulo P in a Galois field GF(P) where P is a prime.

3. The method of claim 2 wherein said computing modulo P comprises the steps of raising said numbers to integer exponents.

4. The method of claim 1 wherein determining said session key at said first proxy station is not computable.

5. The method of claim 1 wherein determining said session key at said second proxy station is not computable.

6. The method of claim 1 including the step of exchanging challenges between said first communication location and said second communication location.

7. The method of claim 1 including the step of exchanging challenges comprising digitally signed certificates of authentication between said first proxy station and said second proxy station.

8. The method of claim 1 including the step of exchanging challenges between said first communication location and said first proxy station.

9. The method of claim 1 including the step of exchanging challenges between said second communication location and said second proxy.

10. A method of secure communication between a first and a second communication station, said method comprising the steps of:
a)said first communication station selecting a primitive element of a Galois field GF(P) where P is a prime,
b) raising said primitive element to a first exponent to compute a first number modulo P
c) transferring said first number by said first communication station to a first of at least one proxy station,
d) raising said first number to a second exponent by said first of at least one proxy station, to generate a second number modulo P,
e) transferring said second number to a second of at least one proxy station,
f) raising said second number to a third exponent by said second of at least one proxy station, to generate a third number, modulo P,
g) transferring said third number to said second communication station,
h) raising said third number to a fourth exponent by said second communication station, to generate a session key, modulo P.

11. A method of secure communication between a first and a second communication station, said method comprising the steps of:
a) said first communication station selecting a primitive element of a Galois field GF(P) where P is a prime,
b) raising said primitive element to a first exponent to compute a first number modulo P,
c) transferring said first number by said first communication station to said at least one proxy station,
d) raising said first number to a second exponent by said at least one proxy station to generate a second number modulo P,
e) transferring said second number to said second communication station,
f) raising said second number to a third exponent by said second communication station to generate a session key, modulo P.

12. The method of claim 10 including the step of exchanging challenges between said first communication location and said second communication location.

13. The method of claim 10 including the step of exchanging challenges comprising digitally signed certificates of authentication between said at least one proxy station and said second communication station.

14. The method of claim 10 including the step of exchanging challenges between said first communication location and said at least one proxy station.

15. The method of claim 10 wherein determining said session key at said at least one proxy station is not computable.
